(19) United States
(12) Patent Application Publication
(10) Pub. No.: US 2026/0328682 A1
(43) Pub. Date: Oct. 22, 2026

(54) SYSTEMS AND METHODS FOR IMPROVED QUANTIFICATION WITH POLYMER CHROMATOGRAPHY

(71) Applicant: Dow Global Technologies LLC, Midland, MI (US)

(72) Inventors: Rongjuan Cong, Lake Jackson, TX (US); Phillip M. Tyler, Rosharon, TX (US); Bo Shuang, Missouri City, TX (US); Jingwei Fan, Pearland, TX (US); Dibyaranjan Mekap, Pearland, TX (US); Paul Balding, Lake Jackson, TX (US); Kimberly L. Bailey, Houston, TX (US); William E. Gee, Lake Jackson, TX (US); Mathias Weeks, Lake Jackson, TX (US); Mark R. Diffin, Clute, TX (US); Charles Michael Cheatham, Lake Jackson, TX (US)

(73) Assignee: Dow Global Technologies LLC, Midland, MI (US)

(21) Appl. No.: 19/109,766

(22) PCT Filed: Sep. 7, 2023
(86) PCT No.: PCT/US2023/073617

§ 371 Date: Mar. 7, 2025

Related U.S. Application Data
(60) Provisional application No. 63/405,136, filed on Sep. 9, 2022.

(51) Int. Cl. G01N 21/3577; G01J 3/453; G01N 21/05; G01N 21/35

(52) U.S. Cl. CPC G01N 21/3577; G01J 3/453; G01N 21/05; G01N 2021/3595

(57) ABSTRACT

A method to determine chemical or structural properties of a liquid sample includes illuminating a flow cell containing a liquid mixture of the sample dissolved in a solvent with first and second beams of light at first and second time steps, detecting the first and second beams of light after they have passed through the flow cell at the first and second time steps to determine first and second interferograms, performing Fourier transforms of the first and second interferograms to determine first and second single beam data, determining first and second signal values of the first and second single beam data at a first frequency, adjusting each signal value of the second single beam data based on a ratio of the second signal value to the first signal value to determine adjusted second single beam data, and determining properties of the sample based on the adjusted second single beam data.

### CROSS-REFERENCE TO RELATED APPLICATION

This application claims the benefit of and priority to U.S. Application Ser. No. 63/405,136 filed Sep. 9, 2022, and entitled “SYSTEMS AND METHODS FOR IMPROVED QUANTIFICATION WITH POLYMER CHROMATOGRAPHY”, the entire contents of which are incorporated by reference in the present disclosure.

### TECHNICAL FIELD

The present specification relates to polymer chromatography, and more particularly, to systems and methods for improved quantification with polymer chromatography.

### BACKGROUND

Polymer chromatography is a technique that may be used to measure chemical or structural properties of polymers, such as molecular weight distribution (MWD), chemical composition distribution (CCD), or concentration of the constituents of a polymer sample. In particular, polymer chromatography may be used to measure the MWD, CCD, or other chemical or structural properties of polyolefins such as polyethylene. For example, polyolefins, such as polyethylene and polypropylene, comprise only hydrogen and carbon atoms. Other types of polyolefins, such as ethylene vinyl acetate copolymers, have other types of atoms, such as oxygen atoms in addition to hydrogen and carbon atoms.

One type of polymer chromatography is gel permeation chromatography (GPC), which is a type of size exclusion chromatography (SEC). In GPC, a sample solution is dissolved in a solvent or a solvent mixture. The sample solution is injected on and passed through one or more elution columns comprising porous particles. Larger sized polymer chains will only diffuse in and out of larger pores and will elute from the column more quickly, while smaller sized polymer chains will diffuse in and out of larger and smaller pores and elute from the column more slowly. As such, GPC provides for the separation of a polymer into its components based on their hydrodynamic size.

As the polymer components elute from the column, the components may be detected with a detector. One type of detection mechanism that may be used is Fourier transform infrared spectroscopy (FTIR). FTIR systems impinge a beam of light composed of multiple wavelengths onto a sample. The system then measures the absorbance of the beam of light by the sample. This process is repeated with multiple beams of light containing different combinations of wavelengths. By analyzing the data using Fourier analysis and apodization functions, the absorbance spectrum (or transmittance spectrum) of the sample may be calculated, which may be used to determine various chemical or structural properties of the constituent components of the sample.

Flow cell FTIR may be used to determine properties of a liquid sample, such as a dissolved sample as part of a GPC system, as described above. In particular, a dissolved sample may pass through a flow cell after passing through one or more columns. Light may then be impinged upon the flow cell in order to measure the absorbance properties of the liquid. However, for use in GPC, polyolefins can only be dissolved in a few solvent types at high temperatures, such as 1,2,4-trichlorobenzene (TCB), ortho-dichlorobenzene (ODCB), or xylene. These solvents absorb many of the same light frequencies as polyolefins. As such, typical FTIR detectors will produce data with a low signal-to-noise ratio (SNR) when analyzing polyolefins, thereby reducing their effectiveness for GPC. For example, tetrachloroethene (TCE) is transparent in C—H frequencies but suffers from poor solubility for many high density polyethylenes, and thus cannot be widely used. Filter-based IR detectors, which lack the flexibility of light frequency selection for analysis in comparison to FTIR, have been recently developed (e.g., PolymerChar™). Accordingly, there is a need for an improved flow cell FTIR detector with a high SNR when analyzing polyolefins.

### SUMMARY

In an embodiment, a method to determine one or more chemical or structural properties of a liquid sample mixture is presented. The method may include illuminating a flow cell containing a liquid mixture of the sample dissolved in a solvent with a first plurality of beams of light at a first time step and a second plurality of beams of light at a second time step. The method may further include detecting the first plurality of beams of light after they have passed through the flow cell at the first time step to determine a first interferogram, and detecting the second plurality of beams of light after they have passed through the flow cell at the second time step to determine a second interferogram. The method may further include performing a Fourier transform of the first interferogram to determine first single beam data associated with the liquid mixture, and performing a Fourier transform of the second interferogram to determine second single beam data associated with the liquid mixture. The method may further include determining a first signal value of the first single beam data at a first frequency, determining a second signal value of the second single beam data at the first frequency, determining a first ratio of the second signal value to the first signal value, and adjusting each signal value of the second single beam data based on the first ratio to determine adjusted second single beam data. The method may further include determining the one or more chemical or structural properties of the sample based on the adjusted second single beam data.

In another embodiment, a method may include receiving a first data set comprising a series of data points, performing a first de-noising algorithm on the first data set to obtain a first de-noised data set, calculating a first-order derivative at the first de-noised data set and a second-order derivative of the first de-noised data set, and calculating a relative information density at each data point of the first de-noised data set. The relative information density may comprise a sum of an absolute value of the first-order derivative divided by a maximum absolute value of the first-order derivative across all of the data points of the first de-noised data set, and an absolute value of the second-order derivative divided by a maximum absolute value of the second-order derivative across all of the data points of the first de-noised data set. The method may also include augmenting the first data set based on the relative information density and an augmentation factor by inserting data points into the first data set to obtain an augmented data set, performing the first de-noising algorithm on the augmented data set to obtain an augmented de-noised data set, and removing data points from the augmented de-noised data set corresponding to the data points that were added to the first data set to obtain a second de-noised data set.

In another embodiment, a system to determine one or more chemical or structural properties of a liquid sample may include a light source, one or more elution columns, a flow cell containing a liquid mixture of the sample dissolved in a solvent after passing through the one or more elution columns, and a detector. The light source may illuminate the flow cell with a first plurality of beams of light at a first time step and a second plurality of beams of light at a second time step. The detector may detect the first plurality of beams of light after they have passed through the flow cell at the first time step to determine a first interferogram, and detect the second plurality of beams of light after they have passed through the flow cell at the second time step to determine a second interferogram. The detector may further perform a Fourier transform of the first interferogram to determine first single beam data associated with the liquid mixture, and perform a Fourier transform of the second interferogram to determine second single beam data associated with the liquid mixture. The detector may further determine a first signal value of the first single beam data at a first frequency, determine a second signal value of the second single beam data at the first frequency, determine a first ratio of the second signal value to the first signal value, adjust each signal value of the second single beam data based on the first ratio to determine adjusted second single beam data, and determine the one or more chemical or structural properties of the sample based on the adjusted second single beam data.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example FTIR detector, according to one or more embodiments shown and described herein;

FIG. 2 schematically depicts another example FTIR detector, according to one or more embodiments shown and described herein;

FIG. 3 depicts a schematic diagram of the computing device of FIGS. 1 and 2, according to one or more embodiments shown and described herein;

FIG. 4 schematically depicts a plurality of memory modules of the computing device of FIG. 3, according to one or more embodiments shown and described herein;

FIG. 5A depicts an example interferogram that may be generated by the FTIR detector of FIGS. 1 and 2, according to one or more embodiments shown and described herein;

FIG. 5B depicts an example single beam signal that may be generated by the FTIR detector of FIGS. 1 and 2, according to one or more embodiments shown and described herein;

FIG. 5C depicts an example transmittance that may be generated by the FTIR detector of FIGS. 1 and 2, according to one or more embodiments shown and described herein;

FIG. 6 depicts an example chromatogram that may be generated by the FTIR detector of FIGS. 1 and 2, according to one or more embodiments shown and described herein;

FIG. 7 depicts example transmittance data that may be recorded by the FTIR detector of FIGS. 1 and 2, according to one or more embodiments shown and described herein;

FIG. 8A depicts an example chromatogram that may be generated by the FTIR detector of FIGS. 1 and 2, according to one or more embodiments shown and described herein;

FIG. 8B depicts an example rough de-noised signal that may be generated by the FTIR detector of FIGS. 1 and 2, according to one or more embodiments shown and described herein;

FIG. 8C depicts a first-order derivative of the example rough de-noised signal of FIG. 8B;

FIG. 8D depicts a second-order derivative of the example rough de-noised signal of FIG. 8B;

FIG. 9A depicts an example relative information density that may be generated by the FTIR detector of FIGS. 1 and 2, according to one or more embodiments shown and described herein;

FIG. 9B depicts another view of the relative information density of FIG. 9A;

FIG. 9C depicts an example augmented signal that may be generated by the FTIR detector of FIGS. 1 and 2, according to one or more embodiments shown and described herein;

FIG. 9D depicts an example de-noised augmented signal that may be generated by the FTIR detector of FIGS. 1 and 2, according to one or more embodiments shown and described herein;

FIG. 9E depicts an example final de-noised signal that may be generated by the FTIR detector of FIGS. 1 and 2, according to one or more embodiments shown and described herein;

FIG. 10 depicts a flowchart of an example method for performing internal standardization, according to one or more embodiments shown and described herein; and

FIG. 11 depicts a flowchart of an example method of performing de-noising, according to one or more embodiments shown and described herein.

### DETAILED DESCRIPTION

The embodiments disclosed herein describe systems and methods for improved quantification with polymer chromatography. In particular, embodiments disclosed herein describe a flow cell FTIR detector able to record data with an improved SNR suitable for measuring the properties of polyolefin as part of a polymer chromatography experiment.

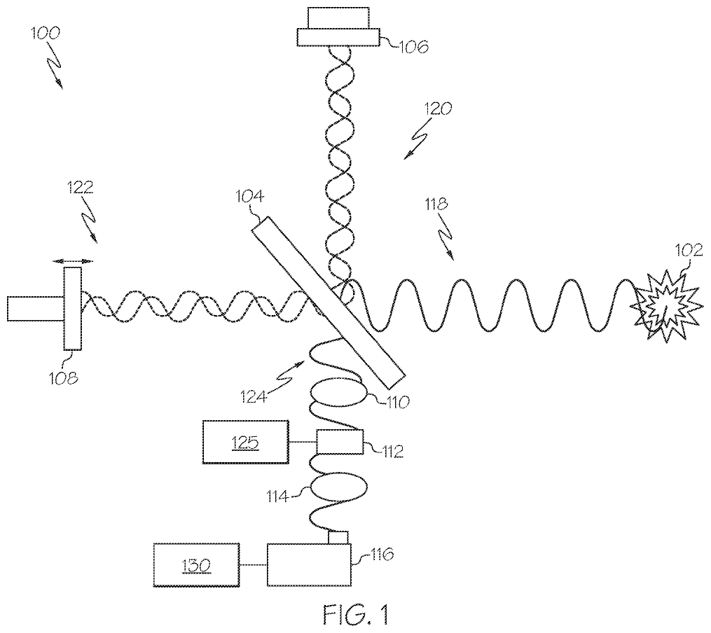

Turning now to the figures, FIG. 1 shows an example flow cell FTIR detector 100, according to embodiments described herein. The flow cell FTIR detector 100 of FIG. 1 includes an emission source 102, a beam splitter 104, a fixed mirror 106, a moving mirror 108, a first focusing mirror 110, a flow cell 112, a second focusing mirror 114, a detector 116, an elution column 125, and a computing device 130.

The emission source 102 may output a beam of light 118 comprised of a plurality of component wavelengths. In the illustrated example, the emission source 102 outputs infrared (IR) light. However, in other examples, the emission source 102 may output other types of light.

The IR light 118 emitted by the emission source 102 may impinge upon the beam splitter 104. The beam splitter 104 may cause a first portion of the light 118 to be reflected towards the fixed mirror 106 as light beam 120, and a second portion of the light 118 to be transmitted and impinge upon the moving mirror 108 as light beam 122. In the illustrated example, the beam splitter causes half of the light 118 to be directed towards the fixed mirror 106 and half of the light 118 to be directed towards the moving mirror 108. However, in other examples, the beam splitter may split the light 118 in other ratios.

The fixed mirror 106 may be positioned at a fixed distance from the beam splitter 104. The light 120 may impinge upon the fixed mirror 106 and be reflected back towards the beam splitter 104. The moving mirror 108 may be positioned at a variable distance from the beam splitter 104. The light 122 may impinge upon the moving mirror 108 and be reflected back towards the beam splitter 104. By changing the position of the moving mirror 108 with respect to the beam splitter 104 during operation of the FTIR detector 100, the phase of the light 122 when impinging on the beam splitter 104 may be changed.

As the reflected beams of light 120 and 122 impinge upon the beam splitter 104, they may be combined into light beam 124 and be directed towards the detector 116. By changing the position of the moving mirror 108 during operation of the FTIR detector 100, the interference pattern between the reflected light beam 120 and the reflected light beam 122 may vary, thereby creating an interferogram when the combined light beam 124 impinges on the detector 116.

The first focusing mirror 110 may focus the light 124 onto the flow cell 112. When measuring the molecular weight of a sample, the larger the flow cell 112 is, the broader the peak of the signal detected by the detector 116 will be. However, as this peak becomes broader, separation efficiency goes down, thereby limiting the spectral resolution of the data and/or the separation resolution of polymer chromatography. Accordingly, it may be desirable to have a smaller flow cell 112. Thus, the first focusing mirror 110 focuses the light 124 onto the flow cell 112 such that the light is focused on the sample in the flow cell 112.

The flow cell 112 may be used to hold a sample to be analyzed, as discussed above. In particular, a sample to be analyzed may be dissolved in a solvent and the combined mixture may flow through the flow cell 112 during operation of the flow cell FTIR detector 100. As discussed above, using a smaller flow cell leads to better separation efficiency when the data is analyzed. As discussed above, when the sample placed in the flow cell 112 is polyolefin, the SNR of the detected data tends to be smaller than would be the case for other samples due to the types of solvents that polyolefin can be dissolved in. Furthermore, using a smaller flow cell 112 (e.g., a having a shorter path length for light) means a smaller volume of liquid is used, which may also lead to a lower SNR of detected data. In conventional FTIR detectors, the SNR may be too low to effectively analyze the chemical or structural properties of polyolefin in chlorinated solvents such as TCB or ODCB. However, the de-noising techniques disclosed herein allow for the analysis of polyolefin directly in chlorinated solvents such as TCB or ODCB in the FTIR detector 100 of FIG. 1. In some examples, the de-noising techniques disclosed herein may be used with non-chlorinated solvents capable of dissolving polyolefins, such as, for example, xylene, decalin, and aliphatic alcohols with improved quantification of polymer chromatography.

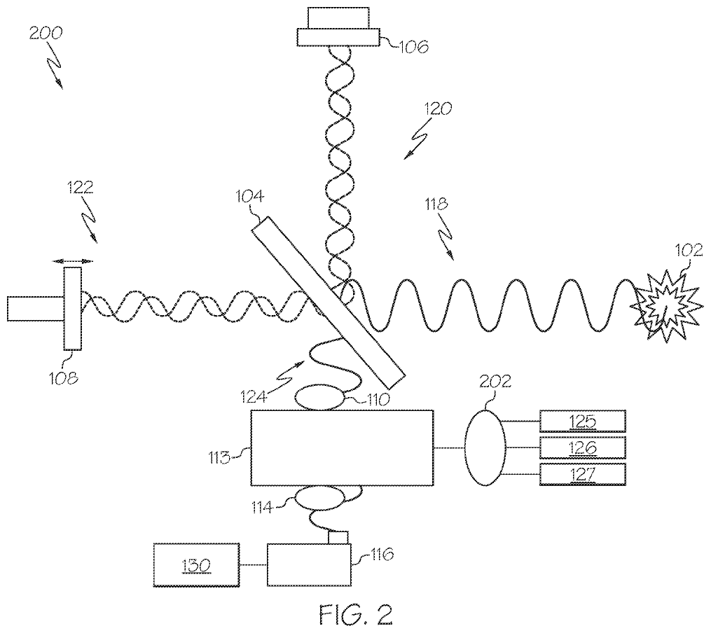

FIG. 2 shows another example flow cell FTIR detector 200. The flow cell FTIR detector 200 is constructed similarly to the flow cell FTIR detector 100 of FIG. 1, except that a flow cell 113 is used instead of the flow cell 112. In particular, the flow cell 113 of FIG. 2 is connected to multiple different elution columns. As such, the valve 202 can be controlled to allow liquid to flow from one particular elution column through the flow cell 113. In the example of FIG. 2, the valve 202 is connected to three elution columns 125, 126, 127. However, in other examples, the valve 202 may be connected to any number of elution columns. In the example of FIG. 2, the valve may individually control the flow of liquid from each of the elution columns 125, 126, 127 through the flow cell 113. Accordingly, different liquids may flow through the flow cell 113 at different times during an FTIR experiment.

Referring back to FIG. 1, The second focusing mirror 114 may focus the light 124 that passes through the flow cell 112 onto the detector 116. In embodiments, the first focusing mirror 110 and the second focusing mirror 114 may be placed the same distance from the flow cell 112 on opposite sides. In addition, the first focusing mirror 110 and the second focusing mirror 114 may have the same focal length. However, in some examples, the first focusing mirror 110 and the second focusing mirror 114 may have different focal lengths and/or may be positioned at different distances from the flow cell 112.

The detector 116 may detect the light 124 that passes through the second focusing mirror 114. In particular, the detector 116 may measure the intensity of the light 124 at a plurality of time steps while the moving mirror 108 is moving. As such, the detector 116 may measure the intensity of the light 124 caused by a variety interference patterns between the reflected light 120 and the reflected light 122 to create an interferogram. The detector 116 may then perform a Fourier transform of the interferogram to obtain a single beam spectrum. By comparing a first single beam spectrum obtained when a sample is present in the flow cell 112 to a background single beam spectrum (e.g., obtained when there is only solvent and no sample in the flow cell 112), the absorbance spectrum of the sample may be determined. Chemical or structural properties of the sample (e.g., MWD and CCD) may be determined based on the determined absorbance spectrum, as discussed in further detail below.

In the example of FIG. 1, a single detector 116 is shown. However, in other examples, multiple detectors may be used. For example, in addition to an FTIR detector, a light scattering detector may also be used. In these examples, a ratio may be determined between data captured by multiple detectors in order to measure additional properties of the sample, such as absolute Mw or viscosity of eluent.

The elution column 125 may be utilized to separate the components of a polymer sample to be analyzed. In the illustrated example, the elution column 125 comprises gel particles as part of a GPC system. However, in other examples, the elution column 125 may comprise other materials and other mechanisms may be used to separate the polymer sample. In the illustrated example, as a liquid mixture comprising a liquid polymer sample dissolved in a solvent passes through the elution column 125 and the components of the sample are separated based on their hydrodynamic size. In particular, the larger polymer chains elute through the column 125 before the smaller polymer components. As such, time series data may be determined as different components of the sample pass through the flow cell 112 at different times. Chemical or structural properties of the sample may then be determined based on the time series data, as discussed in further detail below. In the illustrated example, as a liquid mixture comprising a liquid polymer sample dissolved in a solvent mixture passes through the elution column 125, the components of the sample are separated based on their hydrodynamic size, as discussed above.

The elution column 125 may be utilized to separate the components of a polymer sample to be analyzed. In the illustrated example, the elution column 125 comprises surface inert particles. However, in other examples, the elution column 125 may comprise other materials and other mechanisms may be used to separate the polymer sample. For example, crystallization-based separation may be used to obtain chemical composition distribution, and crystallization elution fractionation (CEF) or temperature rising elution fractionation (TREF) may be used to perform chemical composition distribution analysis (CCD). In some examples, interaction chromatography, such as thermal gradient interaction chromatography or solvent gradient liquid chromatography, may be used. In the illustrated example, as a liquid mixture comprising a liquid polymer sample dissolved in a solvent passes through the elution column 125 and the components of the sample are separated based on their hydrodynamic size, time series data may be determined as different components of the sample pass through the flow cell 112 at different times. Chemical or structural properties of the sample may then be determined based on the time series data, as discussed in further detail below.

The elution column 125 may be utilized to separate the components of a polymer sample having a certain amount of cross-linking (e.g., insoluble in solvent). For example, the elution column 125 may separate cross-linked polyethylene gel from non-cross-linked polyethylene molecules. In the illustrated example, the elution column 125 comprises one or more filters. In the illustrated example, as a liquid mixture comprising a polymer sample dissolved in a solvent passes through the elution column 125 and the components of the sample are separated based on their ability to pass through the filters, time series data may be determined as different components of the sample pass through the flow cell 112 at different times. Chemical or structural properties of non-cross-linked components may then be determined based on the time series data, as discussed in further detail below.

In the example of FIG. 1, a single elution column 125 is shown. However, it should be understood that in other examples, multiple elution columns may be utilized. For example, in the example of FIG. 2, the flow cell FTIR detector 200 comprises three elution columns 125, 126, 127.

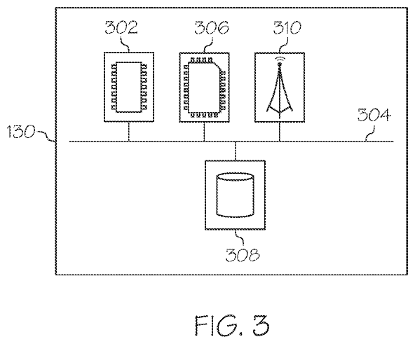

Referring back to FIG. 1, the computing device 130 may be communicatively coupled to the detector 116 and may perform data analysis based on data received by the detector 116 and/or control one or more operations of the detector 116. In the illustrated example, the computing device 130 is physically present within the same facility as the detector 116. However, in other examples, the computing device 130 may be a remote computing device (e.g., a cloud server). In some examples, the computing device 130 may be part of the detector 116. The computing device 130 is discussed in further detail below with reference to FIG. 3.

FIG. 3 schematically depicts an example configuration of the computing device 130 of FIGS. 1 and 2. In the illustrated example, the computing device 130 includes one or more processors 302, a communication path 304, one or more memory modules 306, a data storage component 308, and network interface hardware 310, the details of which will be set forth in the following paragraphs.

Each of the one or more processors 302 may be any device capable of executing machine readable and executable instructions. Accordingly, each of the one or more processors 302 may be a controller, an integrated circuit, a microchip, a computer, or any other physical or cloud-based computing device. The algorithms, including the trained models, signal preprocessing, and noise removal methods discussed below, may be executed by the one or more processors 302. The one or more processors 302 are coupled to a communication path 304 that provides signal interconnectivity between various modules of the computing device 130. Accordingly, the communication path 304 may communicatively couple any number of processors 302 with one another, and allow the modules coupled to the communication path 304 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 304 may be formed from any medium that is capable of transmitting a signal such as, for example, conductive wires, conductive traces, optical waveguides, or the like. In some embodiments, the communication path 304 may facilitate the transmission of wireless signals, such as WiFi, Bluetooth®, Near Field Communication (NFC) and the like. Moreover, the communication path 304 may be formed from a combination of mediums capable of transmitting signals. In one embodiment, the communication path 304 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

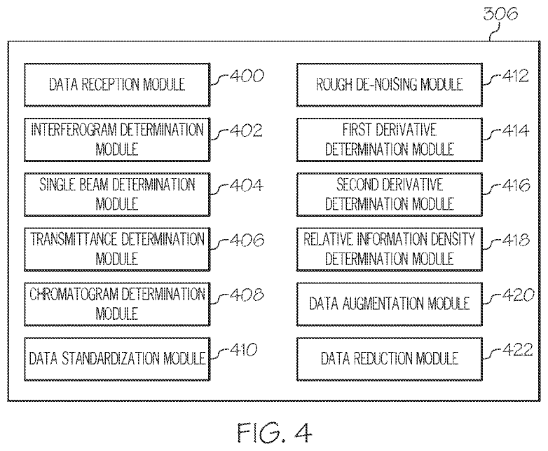

The computing device 130 includes one or more memory modules 306 coupled to the communication path 304. The one or more memory modules 306 may comprise RAM, ROM, flash memories, hard drives, or any device capable of storing machine readable and executable instructions such that the machine readable and executable instructions can be accessed by the one or more processors 302. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 306. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory modules 306 are discussed in more detail below in connection with FIG. 4.

Referring still to FIG. 3, the example computing device 130 includes a data storage component 308. The data storage component 308 may store data received from the detector 116 or data generated by the computing device 130. The data storage component 308 may also store other data used by the various components of the computing device 130.

Still referring to FIG. 3, the computing device 130 comprises network interface hardware 310 for communicatively coupling the computing device 130 to the detector 116. As such, the network interface hardware 310 may send data to and/or receive data from the detector 116. The network interface hardware 310 may comprise a wired and/or wireless connection to the detector 116. In other examples, the network interface hardware 310 may send data to and/or receive data from other computing devices. The network interface hardware 310 can be communicatively coupled to the communication path 304 and can be any device capable of transmitting and/or receiving data via a network. Accordingly, the network interface hardware 310 can include a communication transceiver for sending and/or receiving any wired or wireless communication. For example, the network interface hardware 310 may include an antenna, a modem, LAN port, Wi-Fi card, WiMax card, mobile communications hardware, near-field communication hardware, satellite communication hardware and/or any wired or wireless hardware for communicating with the detector 116 and/or other networks and/or devices.

Referring now to FIG. 4, the one or more memory modules 306 include a data reception module 400, an interferogram determination module 402, a single beam determination module 404, a transmittance determination module 406, a chromatogram determination module 408, a data standardization module 410, a rough de-noising module 412, a first derivative determination module 414, a second derivative determination module 416, a relative information density determination module 418, a data augmentation module 420, and a data reduction module 422. Each of the data reception module 400, the interferogram determination module 402, the single beam determination module 404, the transmittance determination module 406, the chromatogram determination module 408, the data standardization module 410, the rough de-noising module 412, the first derivative determination module 414, the second derivative determination module 416, the relative information density determination module 418, the data augmentation module 420, and the data reduction module 422 may be a program module in the form of operating systems, application program modules, and other program modules stored in one or more memory modules 306. Such a program module may include, but is not limited to, routines, subroutines, programs, objects, components, data structures and the like for performing specific tasks or executing specific data types as will be described below.

The data reception module 400 may receive data from the detector 116. In particular, the data reception module 400 may receive light intensity data indicating intensities of light that impinge upon the detector 116 after passing through the flow cell 112. In operation, a liquid sample dissolved in a solvent (which may be referred to herein as a liquid mixture) is eluted from the elution column 125. As the eluted mixture exits the column 125, it passes through the flow cell 112. As discussed above, the elution column 125 causes the components of the mixture to be eluted at different times based on their hydrodynamic size. In particular, larger components of the mixture are eluted first, while smaller components of the mixture are eluted later.

While the mixture passes through the flow cell 112, the moving mirror 108 may be continually moved back and forth, thereby causing the reflected light beams 120 and 122 to create different interference patterns when they recombine at the beam splitter 104. The different interference patterns may cause the combined light beam 124 to have different frequency components as the moving mirror 108 is moved. While the moving mirror 108 is moving, the detector 116 may continually measure the intensity of the light beam 124 impinging on the detector 116 after passing through the flow cell 112, thereby collecting a plurality of data points. This data may then be transferred by the detector 116 to the computing device 130, and may be received by the data reception module 400.

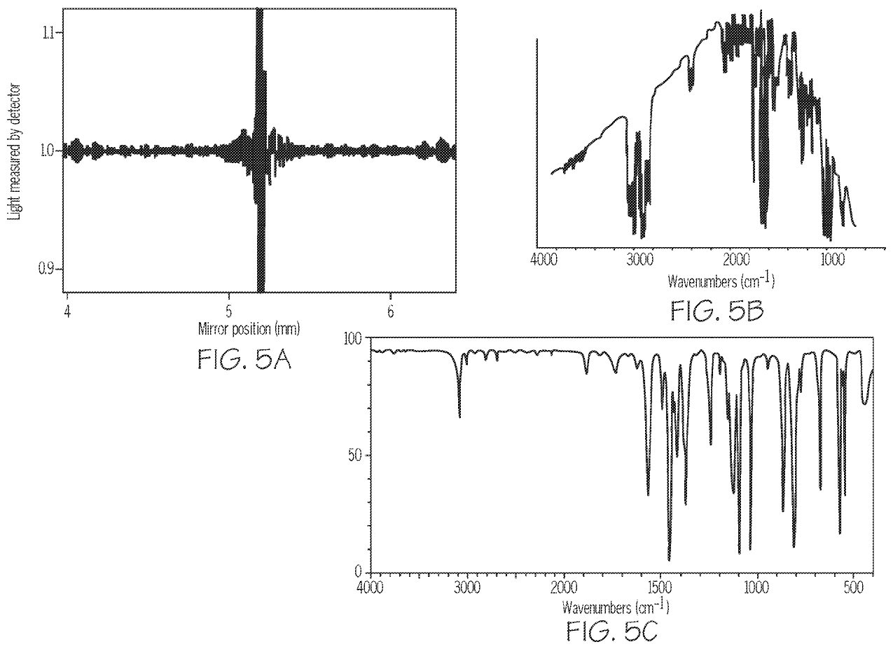

The interferogram determination module 402 may determine a plurality of interferograms based on the data received by the data reception module 400, as disclosed herein. When the moving mirror 108 has made one complete movement path, a complete cycle of constructive and destructive interference may occur between the reflected light beams 120 and 122. The intensity of the light beam 124 that impinges on the detector 116 during this cycle comprises an interferogram. As such, after the data reception module 400 receives data from the detector comprising light intensity data from one complete pass of the moving mirror 108, the interferogram determination module 402 may determine an interferogram based on the received data. An example interferogram is shown in FIG. 5A.

Furthermore, as discussed above, different components of the liquid mixture elute from the column 125 and pass through the flow cell 112 at different times. As such, the moving mirror 108 may continue moving through multiple cycles of its movement path as the liquid mixture flows through the flow cell 112. Each time that the moving mirror 108 moves through a cycle of its movement path, the interferogram determination module 402 may determine an interferogram based on the data received by the data reception module 400 during that movement path of the moving mirror 108. Thus, the interferogram determination module 402 may determine a plurality of interferograms at a plurality of time steps as different components of the liquid mixture are present in the flow cell 112. As such, the different interferograms determined by the interferogram determination module 402 may be used to determine the chemical or structural properties of different components of the sample, as disclosed herein. Thus, the different interferograms determined by the interferogram determination module 402 may be used to determine the concentrations of different components of the sample, as disclosed herein.

Referring back to FIG. 4, the single beam determination module 404 may determine single beam data based on each interferogram determined by the interferogram determination module 402. In particular, the single beam determination module 404 may determine single beam data by performing a Fourier transform of an interferogram determined by the interferogram determination module 402 using any method of performing Fourier transforms. An example single beam is shown in FIG. 5B. A single beam, as determined by the single beam determination module 404, indicates an intensity of light that impinges on the detector 116 after passing through the flow cell 112 at different frequencies. In the example of FIG. 5B, intensity of light is plotted against wavenumber measured in cm⁻¹.

In embodiments, the detector 116 may record one set of measurements when the liquid mixture comprising a sample dissolved in a solvent is eluted from the column 125, and another set of measurements when only the solvent is eluted from the column 125. The measurements recorded when just the solvent is eluted from the column 125 may be used as a background signal and the measurements recorded when the mixture is eluted from the column 125 may be compared to the background signal, as explained below.

Referring still to FIG. 4, the transmittance determination module 406 may determine a transmittance associated with the sample, as disclosed herein. As discussed above, the detector 116 may record data when the liquid mixture comprising the sample dissolved in the solvent is eluted from the column 125, and may also record data when only the solvent is eluted from the column 125. The data reception module 400 may receive both sets of data from the detector. The interferogram determination module 402 may then calculate interferograms for each set of data and the single beam determination module 404 may calculate single beams for each set of data. The transmittance determination module 406 may then calculate a ratio between a single beam from data gathered when the sample mixture was eluted from the column 125, and a single beam from data gathered when only the solvent was eluted from the column 125 (i.e., a ratio between sample data and background data). This ratio may comprise a transmittance of the sample. FIG. 5C shows an example transmittance that may be determined by the transmittance determination module 406. The transmittance determination module 406 may determine a transmittance for each single beam determined by the single beam determination module 404. As such, the transmittance determination module 406 may determine a plurality of transmittances at different time steps as different components of the sample are eluted from the column 125.

Referring back to FIG. 4, the chromatogram determination module 408 may determine a chromatogram based on a plurality of transmittances determined by the transmittance determination module 406. In particular, the chromatogram determination module 408 may determine an absorbance profile, within a particular wavelength band, for a sample as the sample mixture is eluted by the column 125, as disclosed herein.

As described above, the transmittance determination module 406 may determine a plurality of transmittances associated with a sample at a plurality of time steps as a sample mixture is eluted from the column 125. The chromatogram determination module 408 may first convert a transmittance associated with the sample determined by the transmittance determination module 406 into an absorbance associated with the sample using known techniques. The chromatogram determination module 408 may perform this conversion for any number of transmittances determined by the transmittance determination module 406. The chromatogram determination module 408 may then determine a chromatogram based on the determined absorbances s, as disclosed herein.

As discussed above, the transmittance determination module 406 may determine a transmittance associated with the sample at a plurality of time steps while the sample mixture is eluted form the column 125. Accordingly, the chromatogram determination module 408 may determine an absorbance associated with the sample at a plurality of time steps while the sample mixture is eluted from the column 125. The chromatogram determination module 408 may then select a particular wavelength range of interest (e.g., 720-700 cm⁻¹) for which a chromatogram is to be determined. For example, the chromatogram determination module 408 may select a wavelength range associated with a known component of the sample.

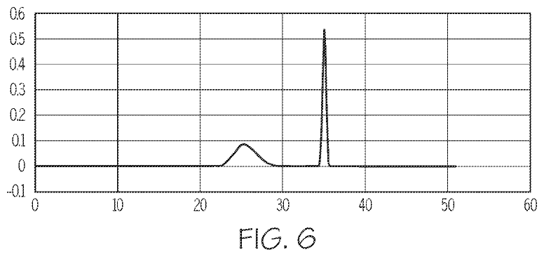

The chromatogram determination module 408 may then determine the absorbance within this wavelength range for each of the absorbances associated with the sample to generate a chromatogram. That is, the chromatogram determination module 408 may create a chromatogram comprising the absorbance associated with the sample within the selected wavelength range of interest at a plurality of time steps while the sample mixture is eluted from the column 125. An example chromatogram that may be determined by the chromatogram determination module 408 is shown in FIG. 6, which plots absorbance against retention time in minutes.

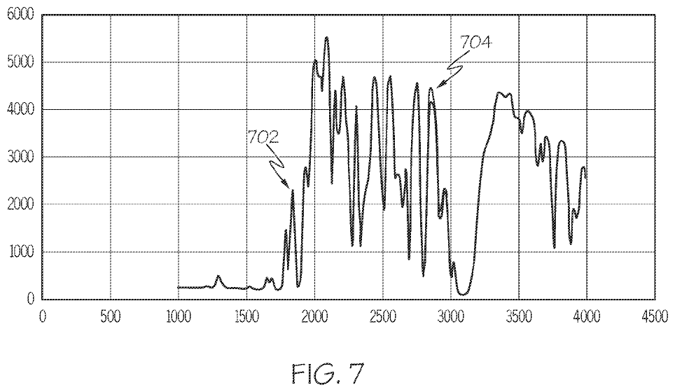

The chromatogram determination module 408 may determine a chromatogram associated with a sample as discussed above. However, as discussed above, a chromatogram is based on a ratio of a sample signal and a background signal. And as discussed above, for polyolefins, the solvents in which they may be dissolved absorb many of the same wavelengths as the polyolefins themselves, thereby making it difficult to distinguish between the sample signal and the background signal. For example, FIG. 7 shows an example single beam signal for a sample polyolefin dissolved in a solvent. The plot 702 shows the background signal of the solvent alone, while plot 704 shows the signal from the sample dissolved in the solvent. As can be seen in FIG. 7, the signals overlap for all but a small wavelength range. As such, the SNR for such a sample is small. Accordingly, any variations in measurement caused by fluctuations in instrument temperature, input light intensity, and the like over time may be extremely detrimental to measurement accuracy. Thus, disclosed herein are two de-noising techniques for improving the SNR when performing an FTIR experiment involving polyolefins using the techniques described herein.

A first de-noising technique that may be performed is an internal standardization procedure. Referring back to FIG. 4, the data standardization module 410 may perform this internal standardization procedure, as disclosed herein. Initially, a baseline wavelength may be selected which is known to have little or no absorbance by the sample of interest. For example, the sample of interest may have a known absorbance below a predetermined threshold value at the baseline wavelength. As such, any absorbance detected at the baseline wavelength is only caused by the solvent itself. This baseline wavelength may be selected by a user based on known properties of the sample of interest.

Once a baseline wavelength is selected, the data standardization module 410 may determine an absorbance value at the baseline wavelength for the first single beam signal determined by the single beam determination module 404. The data standardization module 410 may then store this absorbance value as a baseline absorbance. As each subsequent single beam signal is determined by the single beam determination module 404 at subsequent time steps, the data standardization module 410 may determine the absorbance value at the baseline wavelength. Because the baseline wavelength is selected at a wavelength having no contribution from the sample, there should be no variation in the absorbance value at the baseline wavelength over time. However, because of variations in instrument temperature, input light intensity, and other factors, variations may be introduced due to these factors. Thus, any variation in signal value at the baseline wavelength is presumed to be introduced due to noise rather than signal. Accordingly, each subsequent single beam signal may be adjusted based on the measured absorbance value at the baseline wavelength, as disclosed herein.

In particular, for a subsequent single beam signal after the initial single beam signal, all data points of the subsequent single beam signal may be proportionally scaled based on a ratio of the absorbance values at the baseline wavelength. For example, if the absorbance value at the baseline wavelength of a first single beam signal has a first value, and the absorbance value at the baseline wavelength of a second single beam signal at a subsequent time step is 2% greater than the first value, it can be presumed that this 2% increase was caused by noise rather than signal. Accordingly, the data standardization module 410 may reduce every data point of the second single beam signal by 2% to offset the effect of this noise. The data standardization module 410 may perform this technique for each single beam signal determined by the single beam determination module 404. As such, the data standardization module 410 may determine adjusted single beam signals that more accurately reflect the signal generated by the sample, rather than noise. The chromatogram determination module 408 may then determine a chromatogram based on the adjusted single beam signals to generate more accurate data with a greater SNR.

In some examples, the data standardization module 410 may perform internal standardization based on two baseline wavelengths. For example, two different baseline wavelengths may be selected which are known to have little or no absorbance by the sample of interest. For example, the two baseline wavelengths may be selected where a non-measurable difference between the sample of interest and the solvent was observed. In addition, the transmittance values at the two baseline wavelengths and the wavelengths themselves may be substantially different. For example, the transmittance at one baseline wavelength may be less than 50% of the transmittance at the other baseline wavelength.

The data standardization module 410 may then determine and store absorbance values of the first single beam signal at each of these two baseline wavelengths. As each subsequent single beam signal is determined by the single beam determination module 404 at subsequent time steps, the data standardization module 410 may determine the absorbance values of the single beam signal at each of the two selected baseline wavelengths. The data standardization module 410 may then scale the absorbance values of the subsequent single beam data at the two baseline wavelengths based on a ratio between the absorbance values of the first single beam signal and the absorbance values of the subsequent single beam data at the respective baseline wavelengths (e.g., using linear regression). The data standardization module 410 may then scale all other data points at other wavelengths of the subsequent single beam signal based on the amount of scaling performed at the two baseline wavelengths (e.g., using linear interpretation).

In some examples, the data standardization module 410 may perform internal standardization based on three or more baseline wavelengths in a similar manner. In some examples, the data standardization module 410 may perform internal standardization based on transmittance rather than absorbance.

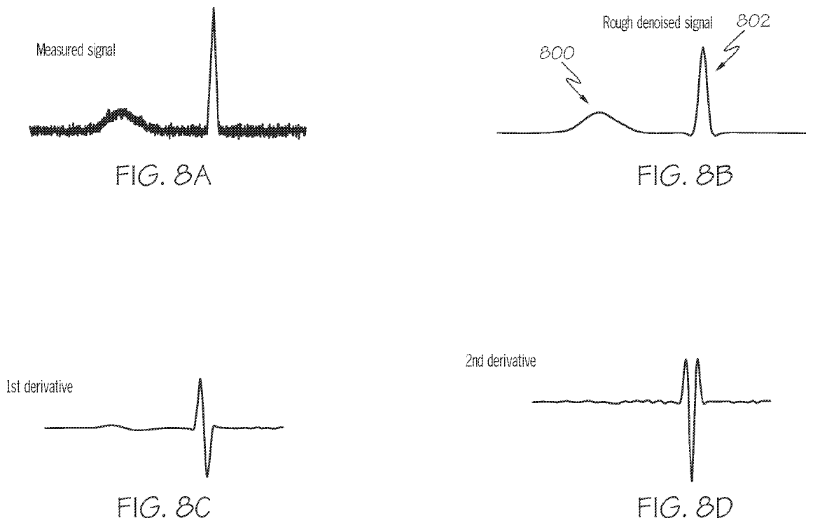

In addition to the internal standardization procedure discussed above, a second de-noising technique can be performed in addition to or instead of the internal standardization procedure, as disclosed herein. In the illustrated example, this second de-noising technique can be performed on a chromatogram determined by the chromatogram determination module 408. FIG. 8A shows an example chromatogram on which this de-noising technique may be performed. In other examples, the second de-noising technique can be performed on a chromatogram determined by another detector or another type of detector. Examples of other types of detectors that may be used include a light scattering detector, a viscometer, and a differential reflective index detector, among others. In some examples, the second de-noising technique can be performed on data other than chromatograms (e.g., any equally spaced one-dimensional data).

Referring back to FIG. 4, the rough de-noising module 412 performs a rough de-noising of a chromatogram determined by the chromatogram determination module 408 using a known de-noising algorithm. In the illustrated example, the rough de-noising module 412 performs a rough de-noising by calculating a wavelet transform of the chromatogram using the à trous algorithm, and then combining the wavelet frequency components above a cut-off frequency used for the wavelet transform to generate a rough de-noised signal associated with the chromatogram. In embodiments, the cut-off frequency used for the wavelet transform may be set by a user. In other examples, other de-noising algorithms may be utilized to determine a rough de-noised signal associated with the chromatogram. The wavelet transform can be repeated several times, for example, 2-10 times or a greater number of times.

FIG. 8B shows an example rough de-noised signal that may be generated by the rough de-noising module 412 from the chromatogram of FIG. 8A As can be seen in the figures, the example rough de-noised signal of FIG. 8B is less noisy than the chromatogram of FIG. 8A. However, the peaks 800 and 802 of the rough de-noised signal of FIG. 8B are not particularly sharp. As such, the additional de-noising techniques described below may improve and protect the sharp peaks of a chromatogram.

Referring back to FIG. 4, the first derivative determination module 414 may calculate a first-order derivative of the rough de-noised signal generated by the rough de-noising module 412, and the second derivative determination module 416 may calculate a second-order derivative of the rough de-noised signal generated by the rough de-noising module 412. An example first-order derivative of the rough de-noised signal of FIG. 8B is shown in FIG. 8C, and an example second-order derivative of the rough de-noised signal of FIG. 8B is shown in FIG. 8D.

Referring back to FIG. 4, the relative information density determination module 418 may determine a relative information density at each point of the rough de-noised signal determined by the rough de-noising module 412 based on the first-order derivative and the second-order derivative determined by the first derivative determination module 414 and the second derivative determination module 416, respectively, as disclosed herein. In particular, the relative information density determination module 418 may determine a relative information density using the following technique.

For each point of the rough de-noised signal, the relative information density determination module 418 may determine the first-order derivative at the data point and the second-order derivative at the data point. The relative information density determination module 418 may also determine a maximum absolute value of the first-order derivative across the entire rough de-noised signal and a maximum absolute value of the second-order derivative across the entire rough de-noised signal.

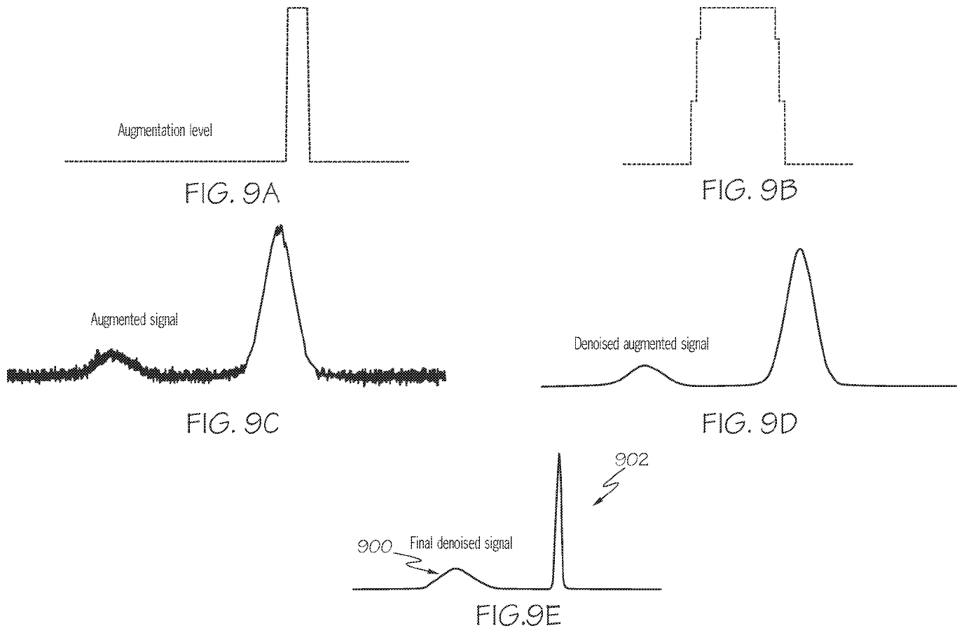

For the particular point of the rough de-noised signal being considered, the relative information density determination module 418 may then determine the sum of the first-order derivative of the rough de-noised signal at that point divided by the maximum absolute value of the first-order derivative, and the second-order derivative at that point divided by the maximum absolute value of the second-order derivative. This sum may comprise the relative information density for one point of the rough de-noised signal. The relative information density determination module 418 may similarly compute the relative information density at each point of the rough de-noised signal to generate the relative information density for the entire rough de-noised signal. The relative information density determined by the relative information density determination module 418 may be used as an augmentation level, as described below. FIG. 9A shows an example relative information density or augmentation level determined by the relative information density determination module 418. FIG. 9B shows a zoomed-in version of the example relative information density or augmentation level of FIG. 9A.

Referring back to FIG. 4, the data augmentation module 420 may perform a data augmentation of the original chromatogram, as disclosed herein. In particular, the data augmentation module 420 may augment the original chromatogram from which the rough de-noised signal was generated based on the relative information density calculated by the relative information density determination module 418. Augmenting the chromatogram comprises inserting data points in between the existing data points of the chromatogram. The number of data points to be inserted is proportional to the relative information density at each point of the chromatogram, as determined by the relative information density determination module 418. In particular, the number of data points to be inserted at any point of the chromatogram is equal to the relative information density at that point multiplied by an augmentation factor. The augmentation factor may be any number greater than or equal to one, and may be set by a user.

The data augmentation module 420 may augment the chromatogram by inserting the appropriate number of data points (based on the relative information density and the augmentation factor) between each existing data points using a variety of techniques (e.g., linear interpolation, nearest neighbor, cubic spline, best fitting curve, and the like) to generate an augmented signal. FIG. 9C shows an augmented signal that may be generated by the data augmentation module 420.

Referring back to FIG. 4, after the data augmentation module 420 generates an augmented signal, as discussed above, the rough de-noising module 412 may perform a known de-noising algorithm on the augmented signal to generate a de-noised augmented signal. The rough de-noising module 412 may use the same de-noising algorithm to generate the de-noised augmented signal that was used to generate the rough de-noised signal discussed above. FIG. 9D shows an example de-noised augmented signal that may be generated by the data augmentation module 420.

Referring back to FIG. 4, the data reduction module 422 may reduce the de-noised augmented signal by removing data points from the de-noised augmented signal corresponding to the data points that were added by the data augmentation module 420 to generate a final de-noised signal. FIG. 9E shows an example final de-noised signal that may be generated by the data reduction module 422. As can be seen in the figures, the peaks 900 and 902 of the final de-noised signal of FIG. 9E are sharper than the peaks 800 and 802 of the rough de-noised signal of FIG. 8B.

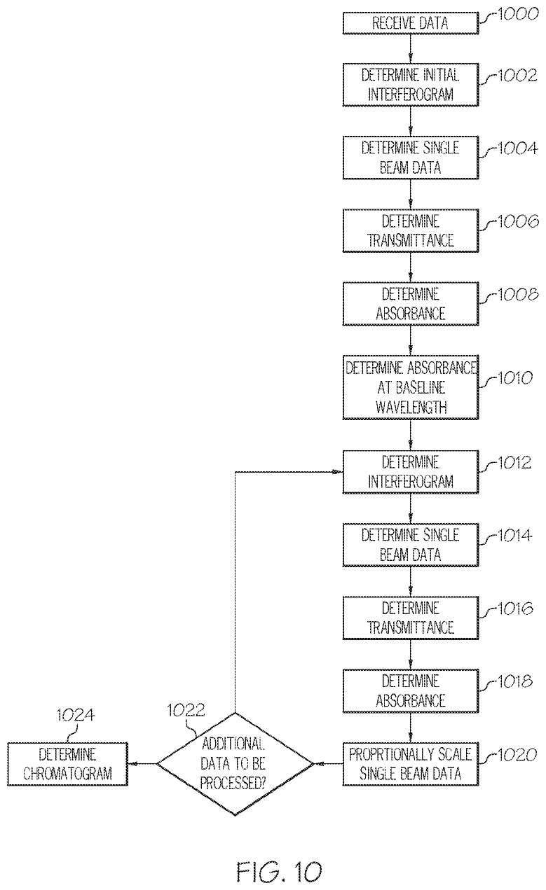

FIG. 10 depicts a flowchart of an example method of performing internal standardization. At step 1000, the data reception module 400 receives data from the detector 116. In particular, the data reception module 400 may receive light intensity data from the detector 116 as the moving mirror 108 moves back and forth and the light beam 124 passes through the flow cell 112. In embodiments, the data reception module 400 may receive one set of data recorded when a sample dissolved in a solvent is eluted from the column 125 through the flow cell 112 and another set of data when only the solvent is eluted from the column 125 through the flow cell 112.

At step 1002, the interferogram determination module 402 determines an initial interferogram based on data received by the data reception module 400. In particular, the interferogram determination module 402 may determine an interferogram comprising light intensity received by the detector 116 as the moving mirror 108 moves through one complete cycle of causing constructive and destructive interference between the light beams 120 and 122 while the sample diluted in the solvent is eluted from the column 125 through the flow cell 112. The interferogram determination module 402 may also determine an interferogram based on data received when only the solvent is eluted from the column 125 through the flow cell 112 to obtain a background interferogram.

At step 1004, the single beam determination module 404 determines single beam data based on the initial interferogram determined by the interferogram determination module 402. In particular, the single beam determination module 404 may determine single beam data by performing a Fourier transform of the initial interferogram determined by the interferogram determination module 402 either with or without using apodization functions. The single beam determination module 404 may also determine a background single beam by performing a Fourier transform of the background interferogram.

At step 1006, the transmittance determination module 406 determines a transmittance based on the single beam data determined by the single beam determination module 404. In particular, the transmittance determination module 406 may determine the transmittance by calculating a ratio between the single beam data associated with the sample and the background single beam. Then at step 1008, the chromatogram determination module 408 may determine an absorbance based on the transmittance determined by the transmittance determination module 406.

At step 1010, the data standardization module 410 determines a value of the absorbance determined by the chromatogram determination module 408 at a baseline wavelength. The baseline wavelength may be selected by a user at a wavelength where the sample is known to have little or no absorbance. As discussed above, in some examples, the data standardization module 410 may perform internal standardization to transmittance values rather than absorbance values.

At step 1012, the interferogram determination module 402 determines a subsequent interferogram based on subsequent data received by the data reception module 400. That is, as explained above, the moving mirror 108 may perform a plurality of passes over time as the sample mixture is eluted from the column 125 in order to obtain data as different components of the sample are eluted. As such, after determining an interferogram associated with a first pass of the moving mirror 108, the interferogram determination module 402 may determine an interferogram associated with a subsequent pass of the moving mirror 108. This may generate an interferogram at a later time step than the initial interferogram.

At step 1014, the single beam determination module 404 determines single beam data based on the subsequent interferogram determined by the interferogram determination module 402. At step 1016, the transmittance determination module 406 determines a subsequent transmittance based on the single beam data determined by the single beam determination module 404. At step 1018, the chromatogram determination module 408 determines a subsequent absorbance based on the transmittance determined by the transmittance determination module 406.

At step 1020, the data standardization module 410 determines a value of the subsequent absorbance at the baseline wavelength. The data standardization module 410 then determines a ratio of the subsequent absorbance value at the baseline wavelength to the initial absorbance value at the baseline wavelength. The data standardization module 410 then proportionally scales each data point of the subsequent single beam data based on this ratio to determine an adjusted single beam signal. For example, if the subsequent absorbance at the baseline wavelength is increased by 1% from the baseline absorbance, then each data point of the subsequent single beam is reduced by 1%. Alternatively, if the subsequent absorbance at the baseline wavelength is decreased by 1% from the baseline absorbance, then each data point of the subsequent single beam is increased by 1%. This may reduce the effect of noise introduced from variations in instrument conditions over the time span in which an experiment is performed.

At step 1022, the interferogram determination module 402 determines whether additional data needs to be processed. That is, the interferogram determination module 402 may determine whether interferograms have been determined for all of the data received by the data reception module 400 or whether additional interferograms need to be calculated. If additional data needs to be processed (YES at step 1022), then control returns to step 1012 and an interferogram for the next time step of the experiment is determined. Alternatively, if no additional data needs to be processed (NO at step 1022), then at step 1024, the chromatogram determination module 408 determines a chromatogram based on the plurality of adjusted single beam signals determined by the data standardization module 410.

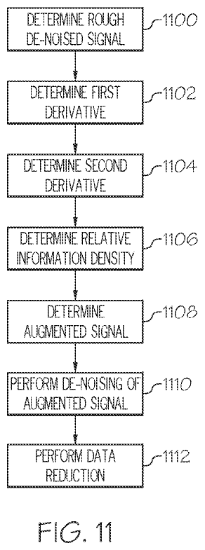

FIG. 11 depicts a flowchart of an example method for performing de-noising as disclosed herein. At step 1100, the rough de-noising module 412 performs de-noising of a chromatogram determined by the chromatogram determination module 408 using a known de-noising algorithm to generate a rough de-noised signal. In the illustrated example, the rough de-noising module 412 performs a wavelet transform using the à trous algorithm and combining the wavelet frequency components above the cut-off frequency. However, in other examples, other de-noising algorithms may be performed.

At step 1102, the first derivative determination module 414 calculates a first-order derivative of the rough de-noised signal determined by the rough de-noising module 412. At step 1104, the second derivative determination module 416 calculates a second-order derivative of the rough de-noised signal determined by the rough de-noising module 412.

At step 1106, the relative information density determination module 418 determines a relative information density at each point of the rough de-noised signal based on the first-order derivative and the second-order derivative determined by the first derivative determination module 414 and the second derivative determination module 416, respectively. In particular, for each point of the rough de-noised signal, the relative information density determination module 418 may calculate a sum of the first-order derivative divided by a maximum absolute value of the first-order derivative, and the second-order derivative divided by a maximum absolute value of the second-order derivative.

At step 1108, the data augmentation module 420 performs a data augmentation of the chromatogram determined by the chromatogram determination module 408 to generate an augmented signal. In particular, for each point of the chromatogram, the data augmentation module 420 may insert a number of data points between an adjacent existing data point equal to the information density at that point multiplied by a user defined augmentation factor. The data augmentation module 420 may insert these data points using a variety of techniques (e.g., linear interpolation, nearest neighbor, cubic spline, best fitting curve, and the like).

At step 1110, the rough de-noising module 412 uses a known de-noising algorithm to perform de-noising of the augmented signal, thereby generating a de-noised augmented signal. Then at step 1112, the data reduction module 422 reduces the de-noised augmented signal. In particular, the data reduction module 422 may reduce data points of the de-noised augmented signal corresponding to the data points added by the data augmentation module 420.

It should now be understood that embodiments described herein are directed to systems and methods for improved quantification with polymer chromatography. A polymer sample may be dissolved in a solvent and eluted from an elution column through a flow cell while infrared light is emitted on the flow cell. The light that is transmitted through the flow cell may be detected by an FTIR detector. In order to improve the signal-to-noise ratio of the collected data, an internal standardization procedure may be performed and a de-noising procedure may be performed.

The internal standardization procedure may adjust the data collected during the course of an experiment based on a signal recorded at a wavelength where the sample is known not to provide any signal. This may reduce the effects of variability in temperature, light source intensity, environment, and other factors during the course of the experiment. The de-noising signal may perform data processing to reduce noise and maintain sharp peaks in chromatograms. As such, the techniques described herein may allow for more accurate measurement of chemical or structural properties of polyolefin in polymer chromatography experiments.

It is noted that the terms “chemical or structural properties” include, but are not limited to, chemical composition, molecular weight, intrinsic viscosity, chain end, unsaturation, long chain branching and corresponding distribution of a sample, and/or the chemical composition and structural properties of the constituent parts of a sample of interest.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method to determine one or more chemical or structural properties of a liquid sample, comprising:
illuminating a flow cell containing a liquid mixture of the sample dissolved in a solvent with a first plurality of beams of light at a first time step and a second plurality of beams of light at a second time step;
detecting the first plurality of beams of light after they have passed through the flow cell at the first time step to determine a first interferogram, and detecting the second plurality of beams of light after they have passed through the flow cell at the second time step to determine a second interferogram;
performing a Fourier transform of the first interferogram to determine first single beam data associated with the liquid mixture, and performing a Fourier transform of the second interferogram to determine second single beam data associated with the liquid mixture;
determining a first signal value of the first single beam data at a first frequency;
determining a second signal value of the second single beam data at the first frequency;
determining a first ratio of the second signal value to the first signal value;
adjusting each signal value of the second single beam data based on the first ratio to determine adjusted second single beam data; and
determining the one or more chemical or structural properties of the sample based on the adjusted second single beam data.

2. The method of claim 1, wherein the sample comprises polyolefins.

3. The method of claim 1, further comprising:
determining a third signal value of the first single beam data at a second frequency;
determining a fourth signal value of the second single beam data at the second frequency;
determining a second ratio of the fourth signal value to the third signal value; and
adjusting each signal value of the second single beam data based on the first ratio and the second ratio.

4. The method of claim 1, wherein at least one of the one or more chemical or structural properties comprises molecular weight distribution.

5. The method of claim 1, wherein at least one of the one or more chemical or structural properties comprise chemical composition distribution.

6. The method of claim 1, wherein the first frequency is a baseline frequency for which the signal value of the first single beam data caused by the sample is below a predetermined threshold.

7. The method of claim 1, further comprising illuminating the flow cell containing the solvent without the sample with a third plurality of beams of light with the flow cell;
detecting the third plurality of beams of light after they have passed through the flow cell containing the solvent without the sample to determine a background interferogram;
performing a Fourier transform of the background interferogram to determine background single beam data; and
determining the one or more chemical or structural properties of the sample based on a ratio of the adjusted second single beam data and the background single beam data.

8. A method comprising:
receiving a first data set comprising a series of data points;
performing a first de-noising algorithm on the first data set to obtain a first de-noised data set;
calculating a first-order derivative of the first de-noised data set and a second-order derivative of the first de-noised data set;
calculating a relative information density at each data point of the first de-noised data set, the relative information density comprising a sum of an absolute value of the first-order derivative divided by a maximum absolute value of the first-order derivative across all of the data points of the first de-noised data set, and an absolute value of the second-order derivative divided by a maximum absolute value of the second-order derivative across all of the data points of the first de-noised data set;
augmenting the first data set based on the relative information density and an augmentation factor by inserting data points into the first data set to obtain an augmented data set;
performing the first de-noising algorithm on the augmented data set to obtain an augmented de-noised data set; and
removing data points from the augmented de-noised data set corresponding to the data points that were added to the first data set to obtain a second de-noised data set.

9. The method of claim 8, further comprising:
illuminating a flow cell containing a liquid mixture of a sample dissolved in a solvent with a plurality of beams of light after the liquid mixture has passed through one or more elution columns;
detecting the plurality of beams of light after they have passed through the flow cell at a plurality of time steps to determine a plurality of interferograms;
performing a Fourier transform of each of the plurality of interferograms to determine a plurality of single beam signals associated with the liquid mixture at the plurality of time steps;
determining a chromatogram based on the plurality of single beam signals as the first data set; and
determining one or more chemical or structural properties of the sample based on the second de-noised data set.

10. The method of claim 8, wherein the first de-noising algorithm comprises a wavelet transform.

11. The method of claim 8, wherein the first de-noising algorithm comprises an à trous algorithm.

12. The method of claim 8, further comprising augmenting the first data set using linear interpolation.

13. The method of claim 8, further comprising augmenting the first data set using nearest neighbor interpolation.

14. The method of claim 8, further comprising augmenting the first data set using cubic spline interpolation.

15. A system to determine one or more chemical or structural properties of a liquid sample, comprising:
a light source;
one or more elution columns;
a flow cell containing a liquid mixture of the sample dissolved in a solvent after passing through the one or more elution columns; and
a detector;
wherein the light source is configured to illuminate the flow cell with a first plurality of beams of light at a first time step and a second plurality of beams of light at a second time step; and
wherein the detector is configured to:
detect the first plurality of beams of light after they have passed through the flow cell at the first time step to determine a first interferogram, and detect the second plurality of beams of light after they have passed through the flow cell at the second time step to determine a second interferogram;
perform a Fourier transform of the first interferogram to determine first single beam data associated with the liquid mixture, and perform a Fourier transform of the second interferogram to determine second single beam data associated with the liquid mixture;
determine a first signal value of the first single beam data at a first frequency;
determine a second signal value of the second single beam data at the first frequency;
determine a first ratio of the second signal value to the first signal value;
adjust each signal value of the second single beam data based on the first ratio to determine adjusted second single beam data; and
determine the one or more chemical or structural properties of the sample based on the adjusted second single beam data.

16. The system of claim 15, wherein the first frequency is a baseline frequency for which the signal value of the first single beam data caused by the sample is below a predetermined threshold.

17. The system of claim 15, further comprising illuminating the flow cell containing the solvent without the sample with a third plurality of beams of light with the flow cell;
detecting the third plurality of beams of light after they have passed through the flow cell containing the solvent without the sample to determine a background interferogram;
performing a Fourier transform of the background interferogram to determine background single beam data; and
determining the one or more chemical or structural properties of the sample based on a ratio of the adjusted second single beam data and the background single beam data.

18. The system of claim 15, wherein the detector is further configured to:
determine a chromatogram based on at least the first signal beam data and the second single beam data;
perform a first de-noising algorithm on the chromatogram to obtain a first de-noised chromatogram;
calculate a first-order derivative of the first de-noised chromatogram and a second-order derivative of the first de-noised chromatogram;
calculate a relative information density at each data point of the first de-noised chromatogram, the relative information density comprising a sum of an absolute value of the first-order derivative divided by a maximum absolute value of the first-order derivative across all of the data points of the first de-noised chromatogram, and an absolute value of the second-order derivative divided by a maximum absolute value of the second-order derivative across all of the data points of the first de-noised chromatogram;
augment the chromatogram based on the relative information density and an augmentation factor by inserting data points into the chromatogram to obtain an augmented chromatogram;
perform the first de-noising algorithm on the augmented chromatogram to obtain an augmented de-noised chromatogram;
remove data points from the augmented de-noised chromatogram corresponding to the data points that were added to the chromatogram to obtain a second de-noised chromatogram; and
determine the one or more chemical or structural properties of the sample based on the second de-noised chromatogram.

19. The system of claim 18, wherein the first de-noising algorithm comprises a wavelet transform.

20. The system of claim 18, wherein the first de-noising algorithm comprises an à trous algorithm.
